(19) United States
(12) Patent Application Publication
(10) Pub. No.: US 2023/0077909 A1
(43) Pub. Date: Mar. 16, 2023

(54) ROAD NETWORK VALIDATION

(71) Applicant: Zoox, Inc., Foster City, CA (US)

(72) Inventors: Taylor Andrew Arnicar, Sunnyvale, CA (US); Christopher James Gibson, Belmont, CA (US); Christopher Patton, Daly City, CA (US); Rohit Wadhwa, Fremont, CA (US)

(21) Appl. No.: 17/476,259

(22) Filed: Sep. 15, 2021

(51) Int. Cl. B60W 60/00; G01C 21/00; G06N 20/00

(52) U.S. Cl. CPC B60W 60/001; G01C 21/3822; G06N 20/00; B60W 2554/4041; B60W 2552/53; B60W 2420/52

(57) ABSTRACT

Techniques for generating and validating map data that may be used by a vehicle to traverse an environment are described herein. The techniques may include receiving sensor data representing an environment and receiving map data indicating a traffic control annotation. The traffic control annotation may be associated, as projected data, with the sensor data based at least in part on a position or orientation associated with a vehicle. Based at least in part on the association, the map data may be updated and sent to a fleet of vehicles. Additionally, based at least in part on the association the vehicle may determine to trust the sensor data more than the map data while traversing the environment.

### BACKGROUND

Maps can be used as a navigational aid to identify a location of an object relative to a larger environment. In an automotive context, road maps are typically used to determine a route for a vehicle to traverse in order to navigate from a starting location to a destination location. Road maps generally convey high-level information that is necessary for a vehicle to navigate from the starting location to the destination location, such as road names, points of interest, landmarks, and other navigational aids.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIGS. 1A and 1B illustrate a pictorial flow diagram of an example process of generating and validating map data representing a road network.

FIG. 2A illustrates example top-down scene data that may be generated using sensor data captured by a vehicle.

FIG. 2B illustrates example map data that may be generated based at least in part on top-down scene data.

FIG. 3A illustrates example projected data in which reference marks are not aligned with their corresponding features of the road network.

FIG. 3B illustrates the example projected data in which the reference marks have been adjusted to align with their corresponding features of the road network.

FIG. 4 illustrates an example user interface of a road network validation tool that may be used to validate routes that are to be traversed by a vehicle.

FIG. 5 illustrates an example method for validating map data according to the various techniques described herein.

FIG. 6 is an illustration of an example system that may be used to implement some of the techniques described herein.

### DETAILED DESCRIPTION

As noted above, road maps are typically used to determine a route for a vehicle to traverse in order to navigate from a starting location to a destination location. Road maps generally convey high-level information that is necessary for a vehicle to navigate from the starting location to the destination location, such as road names, points of interest, landmarks, and other navigational aids including, but not limited to, lane marking, traffic signs, speed limits, and other traffic control information. Although most maps only contain this high-level or low detail information, many modern-day vehicles, including autonomous and/or semi-autonomous vehicles, can benefit from more detailed map data.

Take, for instance, an autonomous vehicle that is configured to operate in an environment without human intervention. The autonomous vehicle may include a plurality of sensors that collect sensor data associated with the environment in order for the vehicle to traverse from a first location to a second location via a road network. In such a scenario, the autonomous vehicle's systems can benefit from highly detailed and accurate maps to traverse the environment safely and effectively. However, generating highly detailed map data (e.g., semantic map data that includes policy information about the environment, such as traffic rules, traffic control annotations, etc.), as well as verifying that the highly detailed map data is valid and/or correct, presents several challenges. For instance, using tools such as satellite imagery or commercially available maps as an aid to generate high-detailed map data can be challenging because only a certain level of accuracy can be attained. For example, road surface markings that can be seen through satellite imagery can be traced to generate map data, but the traced surface markings could be inaccurate (e.g., misaligned due to tracing inaccuracies, image inaccuracies, scaling issues, etc.). Additionally, data (e.g., sensor data of the environment) that may be necessary to confirm the validity or correctness of the map data may still need to be captured to verify the map data is accurate.

This disclosure is directed to techniques for, among other things, validating map data associated with a road network such that the map data can be used by a vehicle to traverse the road network. The map data may be a semantic map that includes policy information about the environment and/or road network, such as traffic rules, traffic control annotations, traffic lights, traffic signs, and the like. For instance, the map data may be generated by a human cartographer and/or an autonomous, computer-based cartographer based on sensor data (e.g., image data, lidar data, top-down scene data, etc.) captured by a vehicle. The map data may include multiple reference marks representing actual features of the road network, such as road surface markings, road surface edges, curbs, and the like. The map data may be projected into image data representing at least the road network from a perspective of a vehicle, and the position of the reference marks relative to the features of the road network may be compared. If the position of the reference marks do not correspond with the actual location of the road network features, then the reference marks may be corrected/adjusted. For instance, a reference mark may represent a centerline road surface marking separating a first lane from a second lane. If the reference mark does not appear in the projected data in the same location as the centerline road surface marking, the position of the reference mark may be adjusted (e.g., confirming, via another vehicle, that the map has changed, updating map data, or otherwise compensating for the difference).

By projecting map data reference marks into actual image data captured by a vehicle (e.g., overlaying semantic information from the map into an image frame), map data can be validated “off-vehicle” in a controlled environment. In other words, map data can be validated without actually having to navigate the vehicle in a safety-critical environment. Additionally, projecting map data reference marks into actual image data to validate the map data can save time and resources, since causing a vehicle to traverse different portions of a road network to validate map data can be time and resource intensive. These and other advantages will be readily apparent to those having ordinary skill in the art. Of course, though discussed with respect to projecting information into image data, the techniques are not meant to be so limiting. Additionally, or alternatively, traffic control devices (e.g., signs, lane markings, lights, etc.) can be projected into other sensor data (e.g., radar, lidar, time-of-flight, etc.) and/or such image representations may be projected (or transformed) into the similar representation in the space of the map (otherwise referred to herein as a semantic map or road network or road network map) for comparison.

By way of example, and not limitation, the various techniques described herein may include receiving sensor data (e.g., image data, lidar data, etc.) and, based on such sensor data, determining a representation of a top-down perspective view of an environment in which a vehicle is capable of operating (e.g., a road network). The sensor data may have been captured by a sensor system of the vehicle. Based at least in part on the sensor data, map data (or semantic map data) may be generated or otherwise determined. For instance, a cartographer or automated system may provide annotations to indicate traffic control information associated with the sensor data (e.g., lane markings, speed control devices, crosswalks, and the like), and other semantic information associated with the road network. The reference marks may correspond with, or otherwise represent, road surface markings, road surface edges, lanes, barriers (e.g., curbs, sidewalks, etc.), road surface textures, and the like. In at least one example, the sensor data is lidar data that represents road surface markings of a road network.

In at least some examples, such sensor data may be associated with log data received from a vehicle operating in an environment. In some examples, the log data may include one or more of image data, lidar data, radar data, elevation/altitude data, and/or other types of sensor data, as well as timestamp data. In at least one example, the log data includes image data and timestamp data that is used to generate projected data, as described in further detail below.

In some examples, the map data may be received (e.g., from a localization system) in addition to the log data. The map data may indicate a reference mark associated with a feature of the drivable surface. For instance, the map data may indicate a boundary associated with an edge of the drivable surface (e.g., a lane marking separating a first lane from a second lane, a road surface marking separating a lane from a road shoulder, and the like). In some examples, the feature of the drivable surface may comprise one of a road surface marking or a barrier separating the drivable surface from a non-drivable surface. In at least one example, the feature is a transverse road surface marking representing a stop line, yield line, crosswalk, caution line, and the like.

In some examples, the techniques may include projecting, as projected data, the map data into the sensor (e.g., image) data. The projected data may represent the drivable surface of the environment and the reference/semantic mark or information relative to the image. For instance, the projected data may comprise the image data annotated to include the reference marks relative to the features represented in the image data. In some examples, the projected data is projected based at least in part on a pose associated with a vehicle (e.g., as noted in the log data or sensor data). Additionally, in some examples, the reference marks, as depicted in the projected data, may visually indicate a classification associated with the feature to which the reference mark corresponds. For instance, if the reference mark corresponds with a yellow centerline surface marking, the reference mark may be colored yellow, include text indicative of the yellow centerline, and the like.

In at least one example, the projected data is generated based at least in part on input image data, timestamp data, and the map data, as well as, in some instances, altitude data included in the image data. The altitude data may indicate respective altitudes of various features represented in the image data. In this way, when the map data is projected onto the image data, the map data may have three-dimensional characteristics such that the reference marks may match the different elevation contours of the road network.

In some examples, based at least in part on the projected data, an indication associated with a location of the reference mark may be received. For instance, the indication may indicate that the reference mark is to be adjusted such that the reference mark is in the same position of the image as the feature to which it corresponds. That is, the reference mark may not be positionally aligned with the feature, and the reference mark may need to be adjusted (e.g., moved) to better align with the feature. Additionally, or alternatively, the indication may indicate that the reference mark is in a correct position, as well as how much a reference mark needs to be adjusted, in what direction the reference mark needs to be adjusted, and the like. In some examples, the indication may be received from the human cartographer. Based at least in part on the indication, the map data may be updated to adjust/correct the location of the reference mark to correspond with a location of the feature.

In some examples, the techniques may also include determining that the drivable surface is invalid for use by the vehicle. For instance, the drivable surface may not be wide enough for the vehicle to use, may only be usable by the vehicle in a certain direction (e.g., one-way traffic), and the like. As such, a visualization of the map data may be updated to indicate that the drivable surface is invalid for use by the vehicle. The visualization may be presented on a user interface or other display for viewing by the cartographer, an operator of the vehicle, or the like.

By projecting map data reference marks into actual sensor data captured by a vehicle (e.g., overlaying semantic information from the map into an image frame), map data can be validated “off-vehicle” in a controlled environment. In other words, map data can be validated without actually having to navigate the vehicle in a safety-critical environment, thus improving the safety of autonomous vehicles. Additionally, projecting map data reference marks into actual image data to validate the map data can save time and compute resources, since causing a vehicle to traverse different portions of a road network to validate map data can be time and compute resource intensive.

The techniques described herein can be implemented in a number of ways. Example implementations are provided below with reference to the following figures. Although discussed in the context of an autonomous vehicle, the methods, apparatuses, and systems described herein can be applied to a variety of systems and are not limited to autonomous vehicles. In another example, the techniques can be utilized in any type of vehicle, robotic system, or any system using data of the types described herein.

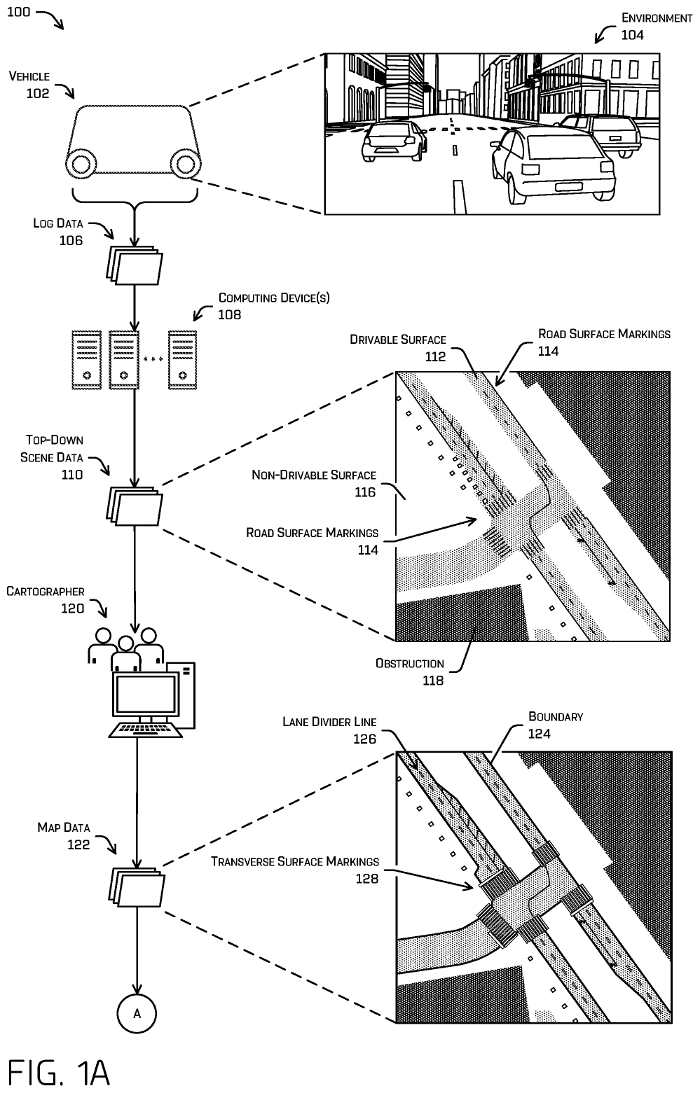

FIGS. 1A and 1B illustrate a pictorial flow diagram of an example process 100 of generating and validating map data representing a road network. A vehicle 102 may operate in an environment 104 and capture log data 106 associated with the environment 104. The log data 106 may include one or more types of sensor data, such as image data, lidar data, radar data, position data, altitude data, timestamp data, and the like. The captured log data 106 may be received by one or more computing devices 108, which may be configured to generate top-down scene data 110 representing the environment 104.

The environment 104 represented in the top-down scene data 110 may include a road network. That is, the top-down scene data 110 may represent a drivable surface 112 that may be driven by the vehicle 102. The drivable surface 112 may include one or more road surface markings 114 (shown in solid lines), such as lane divider markings, median markings, turn lane markings, transverse markings (e.g., crosswalk markings), and the like. The top-down scene data 110 shown may be representative of lidar data captured by the vehicle 102. As such, the different surfaces shown in the top-down scene data 110, such as the drivable surface 112 (represented by light stippling), the non-drivable surface 116 (represented with no stippling), and the obstructions 118 (represented by dark stippling), may correspond with an actual shade intensity associated with those surfaces captured in the lidar data. In other words, the lidar data, indicates different shades and/or color intensities for different surface compositions, as shown in the top-down scene data 110.

A cartographer 120 (e.g., a human cartographer, a machine-learned model, a computing device that is automated to generate map data, etc.) may receive the top-down scene data 110 and use it to generate map data 122. The map data 122 may comprise semantic map data. For instance, the cartographer 120 may use the top-down scene data 110 to draw reference marks, such as road surface boundaries 124, lane divider lines 126, transverse surface markings 128, and the like, as well as to determine annotation data (e.g., semantic information) such that a vehicle, when localized against the map, may use such data for driving. The reference marks may be used at least partially by the vehicle 102 (and/or other vehicles in a fleet of vehicles) to traverse the environment 104. The reference marks, such as the road surface boundaries 124, the lane divider lines 126, and the transverse surface markings 128 (e.g., crosswalk, stop line), may correspond with, or otherwise represent, the real road surface markings 114 that may be visible in the top-down scene data 110, as well as road surface edges, barriers (e.g., curbs, sidewalks, etc.), and the like.

With reference to FIG. 1B, the computing devices 108 may generate projected data 130 based at least in part on the map data 122 and the log data 106. In some examples, the projected data 130 may additionally or alternatively be based at least in part on live sensor data captured by a vehicle. Additionally, the computing devices 108 may generate the projected data based at least in part on a pose associated with the vehicle 102, as indicated in the log data 106. In some examples, the log data 106 may include image data, altitude data, location data, and/or timestamp data associated with the vehicle 102 traversing the environment 104. As such, the projected data 130 may include image data 132 that is annotated to include one or more reference marks of the map data 122, such as the road surface boundary 124, the lane divider line 126, and the transverse surface markings 128, relative to the actual features of the environment, such as the road surface edge 134, road surface markings, and/or other features associated with the environment 104. As shown in the projected data 130, the reference marks may not be positioned in the correct location that corresponds with the actual location of the features. For example, once a position and/or orientation (e.g., a pose) of the vehicle is determined based at least in part on the sensor data, corresponding semantic map data or road network data may be accessed which is associated with the given position and/or orientation. In such an example, elements of the semantic map may be “projected” (or otherwise mapped) to corresponding sensor data such that the semantic information from the map overlays the corresponding sensor data (e.g., image data). Of course, a reverse operation may be equally relied upon for validating the map or sensor data (e.g., projecting the sensor data into a map space). Once in a common frame, discrepancies may be determined. For instance, the boundary 124 is not aligned with the edge 134, the transverse surface markings 128 are not aligned with the crosswalk, and the lane divider line 126 is not aligned with the centerline of the road. In some examples, an appearance of the reference marks may be indicative of the road network feature to which they correspond. For instance, the boundary 124 is shown in a first style of broken line to indicate it corresponds with the edge 134, the lane divider line 126 is shown in a second style of broken line to indicate it corresponds with the centerline, and the transverse surface markings 128 are shown in a third style of broken line to indicate they correspond with the crosswalk. In examples, colors of line, styles of lines, text data, and the like may be used to indicate what feature of a road network that a reference mark corresponds with. In various examples, such features in sensor data may be extracted to form the basis of comparison with the corresponding semantic map data (e.g., lane marking detectors, traffic signal detectors, and the like). Comparisons may be made based on, for example, a determination of intersection over union, difference in Euclidian (or other weighted) distance between features, or any other form for comparison.

Using the projected data 130, the cartographer 120 may adjust the reference such that the map data is updated map data 136 in which the reference marks align with the features of the road network to which they correspond. For instance, the cartographer 120 may adjust the reference marks such that, as shown, the boundary 124 is aligned with the edge 134, the transverse surface markings 128 are aligned with the crosswalk, and the lane divider line 126 is aligned with the centerline of the road. In some examples, a machine-learned model may be trained and used to adjust the reference marks of the semantic map data 122 to align with the features of the environment 104 to automate the process. In some examples, if a difference between the reference marks and the features is determined on-vehicle, the vehicle may trust the sensor data more than the semantic map data.

Once the reference marks of the updated map data 136 have been verified as being aligned with the features of the environment 104, the updated map data 136 may be uploaded to a vehicle (which may or may not be vehicle 102) for use. For instance, the vehicle 102 may comprise an autonomous or semi-autonomous vehicle that at least partially uses the updated map data 136 to traverse the environment 104.

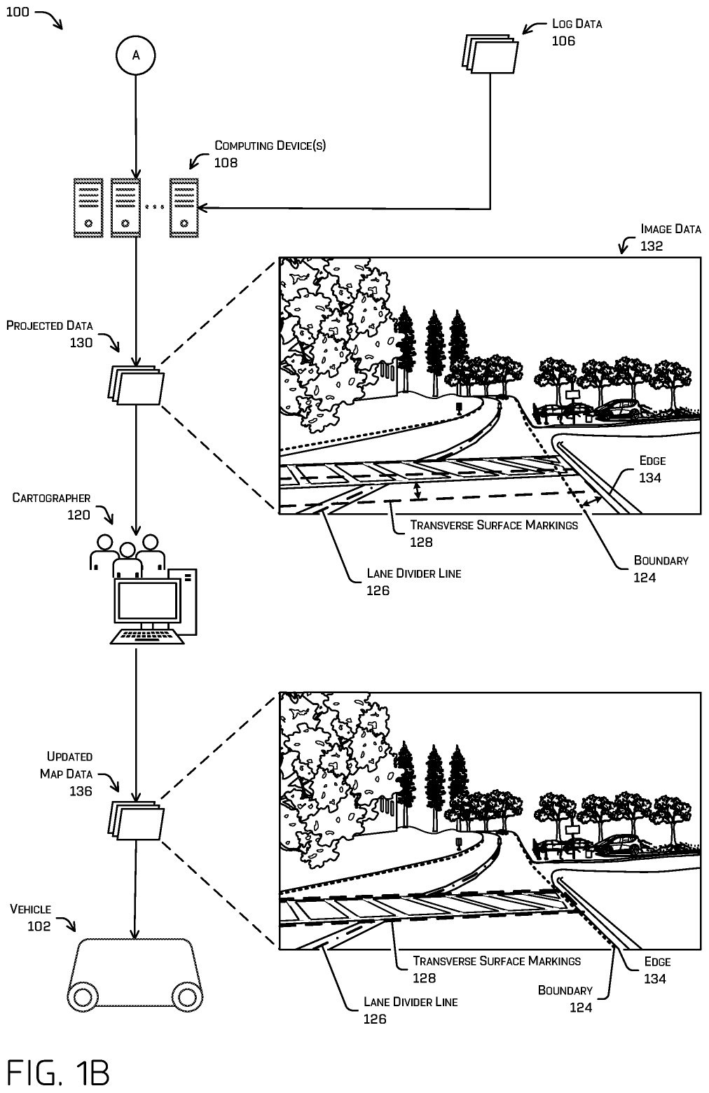

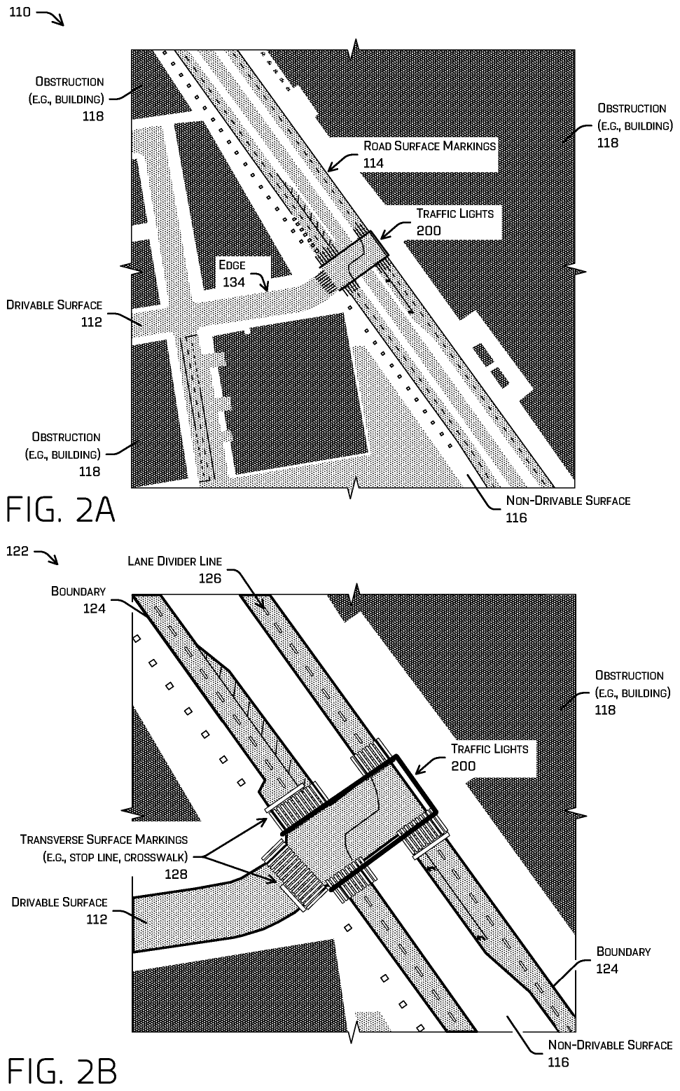

FIG. 2A illustrates example top-down scene data 110 that may be generated using sensor data captured by a vehicle. For instance, the top-down scene data 110 show in FIG. 2A is illustrative lidar data that may be captured by a vehicle. The top-down scene data 110 may represent a road network of an environment.

Because the sensor data used to generate the top-down scene data 110 is lidar data, the top-down scene data 110 may show differences in surface compositions, such as the differences in surface compositions between drivable surfaces 112 (shown in light stippling), non-drivable surfaces 116 (shown with no stippling), and obstructions 118 (e.g., buildings, structures, trees, etc.) (shown in dark stippling). Additionally, the lidar data may represent road surface markings 114. For instance, lidar sensors may pick up or otherwise detect the paint of the road surface markings based at least in part on retro reflectivity properties of the paint. Additionally, the lidar data may indicate transition points, or edges 134, where a drivable surface 112 meets a non-drivable surface 116, where a non-drivable surface 114 meets an obstruction 118, and the like. Even further, the sensor data may indicate locations of traffic lights 200 in the environment.

FIG. 2B illustrates example semantic map data 122 that may be generated based at least in part on top-down scene data 110. For instance, a cartographer or a machine-learned model may use the road surface markings 114 represented in the top-down scene data 110 to generate reference marks of the map data 122, such as the boundaries 124, lane divider lines 126, transverse surface markings 128, as well as other reference marks. Additionally, the cartographer or the machine-learned model may use the other features represented in the top-down scene data to mark certain areas within the map data 122 as drivable surfaces 112, non-drivable surfaces 116, and obstructions 118.

In some examples, the cartographer or the machine-learned model may, while generating the map data 122, ensure that the reference marks are valid. For instance, whether a crosswalk is valid may depend on whether the crosswalk extends fully across a drivable surface 112 (e.g., starting from a first non-drivable surface 116, extending across the drivable surface 112, and ending at a second non-drivable surface 116). Similarly, whether a stop line is valid may depend on whether the stop line fully extends the width of a lane. During the map generation process, as well as the map validation process, cartographers and/or machine-learned models may determine whether these reference marks are valid to ensure proper vehicle operation.

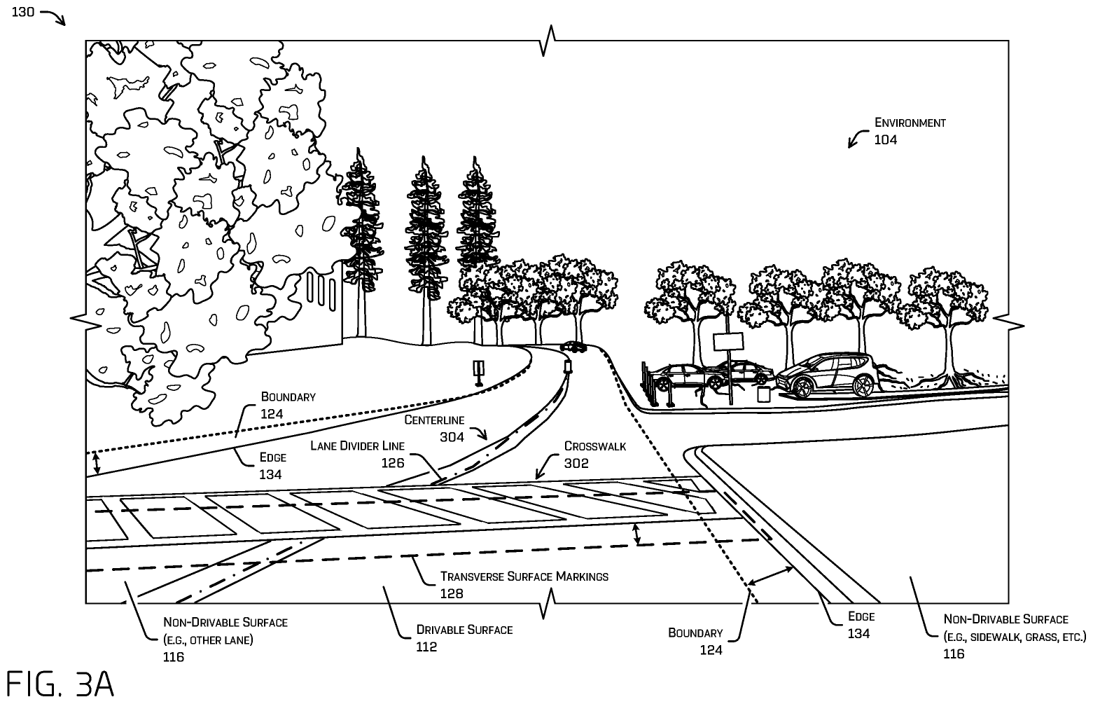

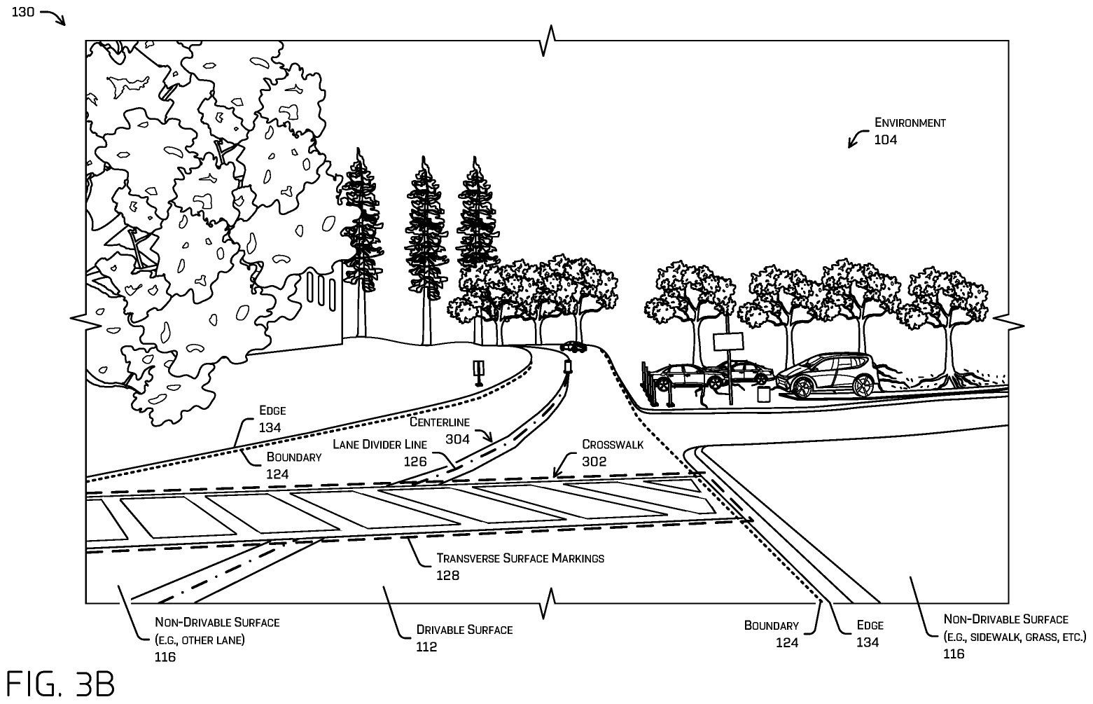

FIG. 3A illustrates example projected data 130 in which the map data reference marks are not aligned with their corresponding features of the road network. The projected data 130 may be generated based at least in part on log data and map data such that positions of map data reference marks may be compared with actual locations of features they correspond with. The log data may include image data representing the environment 104, timestamp data, altitude data, location data, vehicle position (e.g., pose) data, and the like. As used herein, a “pose” of a vehicle means the vehicle's position (e.g., x, y, z) and/or orientation (e.g., roll, pitch, yaw).

The projected data 130 may comprise image data that is annotated to include map data reference marks, such as the boundary 124, the lane divider line 126, and the transverse surface markings 128, as shown. As such, the locations of the reference marks may be compared with the actual locations of the features they correspond with. For instance, a machine-learned model, a comparison component executing on the computing devices 108, and/or the cartographer computing devices 120 may compare the projected data. In some examples, the projected data 130 may indicate that the position of the boundary 124 is not aligned with the location of the road surface edge 134, that the position of the lane divider line 126 is not aligned with the centerline 304, and that the transverse surface markings are not aligned with the crosswalk 302. Additionally, the projected data 130 may indicate which surfaces in the environment are drivable and non-drivable. For instance, the projected data 130 indicates that the right-hand lane is a drivable surface 112, that the left-hand lane is a non-drivable surface 116 (e.g., opposite direction of traffic), and that the region to the right of the right-hand lane is a non-drivable surface 116.

FIG. 3B illustrates the example projected data 130 in which the reference marks have been adjusted (e.g., by a cartographer, machine-learned model, etc.) to align with their corresponding features of the road network. For instance, as compared to FIG. 3A, the boundary 124 reference mark of the map data has been adjusted to align with the edge 134 of the road surface. Similarly, the lane divider line 126 has been adjusted to align with the centerline 304, and the transverse surface markings 128 have been adjusted to align with the perimeter of the crosswalk 302.

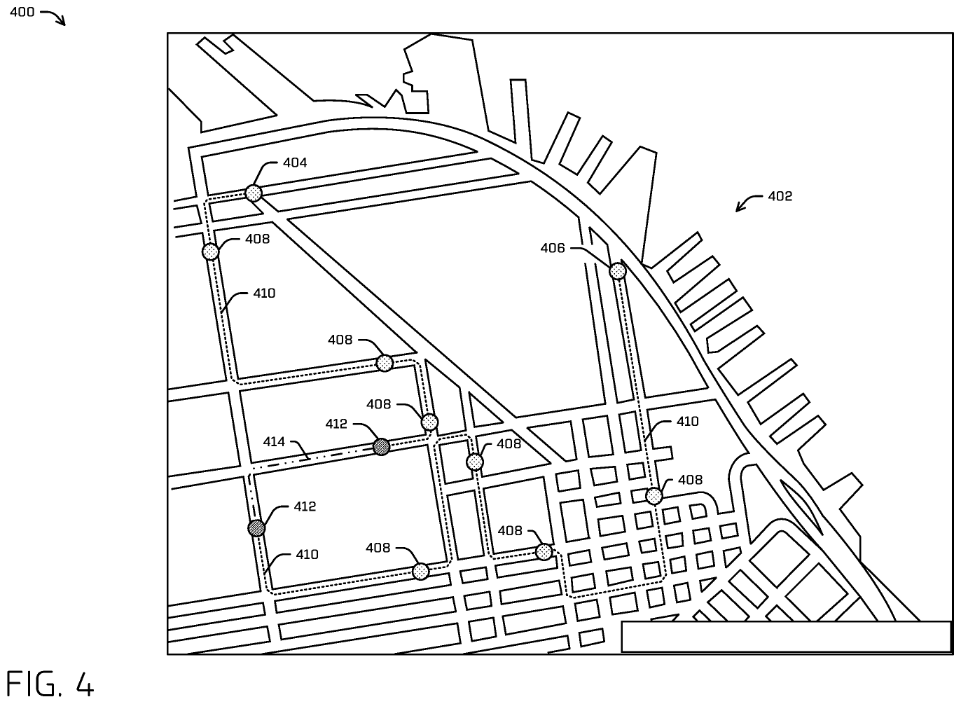

FIG. 4 illustrates an example user interface 400 of a road network validation tool that may be used to validate routes that are to be traversed by a vehicle. The user interface 400 may include a road network 402 associated with an environment. In some examples, the road network 402 of the user interface 400 may be generated based at least in part on map data.

When a vehicle is to traverse the road network from a starting point 404 to a destination point 406, a route may be determined and displayed on the user interface 400. The route may include one or more waypoints 408 along the route and a track line 410 that traces a path of the route that the vehicle is to follow through the environment. In some examples, the route may be selectable by an operator of the vehicle. In some examples, if a route includes a section of roadway that is not valid for use by the vehicle (e.g., the roadway is not wide enough, is under construction, is blocked, has not been mapped, etc.), then the user interface 400 may display the portion of the rout that is not valid for use. For instance, as shown in FIG. 4, the user interface 400 may indicate the section of the route between the waypoints 412 (indicated by the track line 414) that is not valid for use by the vehicle. In this way, the operator of the vehicle may perform a corrective action, such as selecting a new route for the vehicle to take.

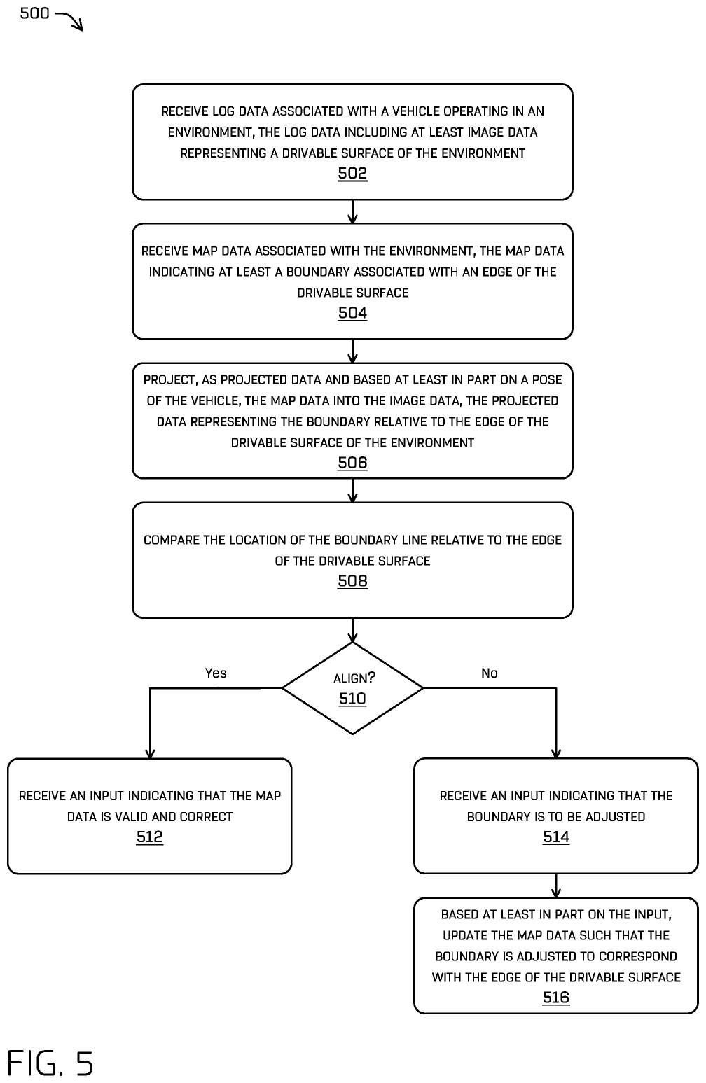

FIG. 5 illustrates an example method 500 for validating map data according to the various techniques described herein. The operations described herein with respect to the method 500 may be performed by various components and systems, such as the components illustrated in FIGS. TA, 1B, and 6.

By way of example, the process 500 is illustrated as a logical flow graph, each operation of which represents a sequence of operations that can be implemented in hardware, software, or a combination thereof. In the context of software, the operations may represent computer-executable instructions stored on one or more computer-readable storage media that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described operations can be combined (or omitted) in any order and/or in parallel to implement the process 500. In some examples, multiple branches represent alternate implementations that may be used separately or in combination with other operations discussed herein.

The method 500 begins at operation 502, which includes receiving log data associated with a vehicle operating in an environment, the log data including at least image data representing a drivable surface of the environment. For instance, the computing devices 108 may receive the log data 106 from the vehicle 102. In some examples, the log data may include image data, lidar data, timestamp data, altitude data, location data, and the like. That is, the log data may include different types of data generated by different sensors and/or sensor systems of the vehicle.

At operation 504, the method 500 includes receiving map data associated with the environment, the map data indicating at least a boundary associated with an edge of the drivable surface. In some examples, the map data may be received based at least in part on the sensor data. For instance, the computing devices 108 may receive the map data 122 associated with the environment. In some examples, the map data includes multiple reference marks associated with features of the environment. For instance, a reference mark may comprise a boundary mark associated with an edge of the drivable surface. Additionally, or alternatively, a reference mark may correspond with a centerline of a road network, a crosswalk, a stop line, a yield line, and the like.

At operation 506, the method 500 includes projecting, as projected data and based at least in part on a pose of the vehicle, the map data into the image data, the projected data representing the boundary line relative to the edge of the drivable surface of the environment. Although described as image data, the map data may be projected into any type of sensor data, such as the image data, lidar data, radar data, or combinations thereof. For instance, the computing devices 108 may project the projected data 130 (e.g., by causing presentation of the projected data on a display) based at least in part on the pose of the vehicle, as indicated in the log data. In some examples, the projected data may comprise image data that is annotated to indicate locations of one or more reference marks included in the map data relative to locations of actual features of the environment that the reference marks correspond with.

In some examples, semantic data associated with the drivable surface may be determined based at least in part on the log data. The map data may also include semantic data, in some examples, which can be determined based on the log data. The semantic data may be indicative of policy information associated with the environment, such as traffic rules, traffic control annotations, traffic lights, traffic signs, and the like.

At operation 508, the method 500 includes comparing the location of the boundary line relative to the edge of the drivable surface. For instance, the cartographer 120 may compare the location of the boundary line relative to the edge of the drivable surface. Additionally, or alternatively, a machine-learned model may be trained and/or used to compare the location of the boundary line relative to the edge of the drivable surface, and an output of the machine learned model may indicate whether the boundary line is aligned with the edge of the drivable surface, a direction and/or magnitude that the boundary line should be adjusted to align with the edge of the drivable surface, and the like.

At operation 510, if the location of the boundary line is aligned within a threshold distance (e.g., x amount of feet, pixels, or other unit of measurement) of the edge of the drivable surface, the method 500 proceeds to operation 512, which includes receiving an input indicating that the map data is valid and correct. For instance, the computing devices 108 may receive the input indicating that the map data is valid and correct from the cartographer 120. However, if the location of the boundary line is not aligned with the edge of the drivable surface, the method 500 proceeds to operation 514. In some instances, the map data may be valid, but not correct, and vice-versa. For instance, if a crosswalk reference mark extends fully across the drivable surface, or a stop line reference mark extends fully across a lane, but the reference marks are not properly aligned with the actual location of the features, then the map data may be considered incorrect. Conversely, if the crosswalk reference mark does not extend fully across the drivable surface, or the stop line reference mark does not extend fully across a lane, but the reference marks are properly aligned with the actual locations of the features, then the map data may be considered invalid. In either case, the method 500 may proceed to operation 514 if the map data is invalid or incorrect.

At operation 514, the method 500 includes receiving an input indicating that the boundary is to be adjusted. For instance, the computing devices 108 may receive the input indicating that the boundary is to be adjusted from the cartographer 120. In some examples, rather than receiving the input to adjust the boundary, the computing devices 108 may determine that the boundary is to be adjusted and do so accordingly. Additionally, or alternatively, the computing devices 108 may receive the input indicating that the boundary is to be adjusted from a machine-learned model. In some instances, the input may indicate a direction and magnitude that the boundary is to be adjusted to align with the edge of the drivable surface. At operation 516, the method 500 includes, based at least in part on the input indicating that the boundary is to be adjusted, updating the map data such that the boundary is adjusted to correspond with (e.g., aligned with) the edge of the drivable surface. For instance, the computing devices 108 may update the map data based at least in part on the input, as well as store the updated map data and/or upload the updated map data to a vehicle for use.

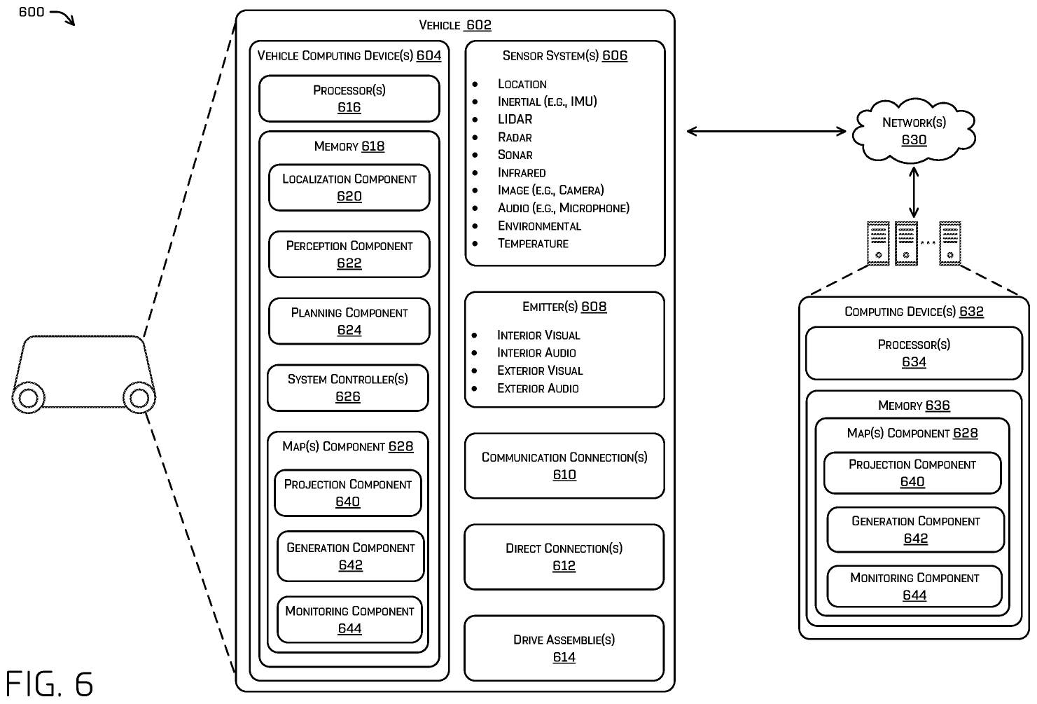

FIG. 6 depicts a block diagram of an example system 600 that may be used to implement some, or all, of the techniques described herein. In some examples, the system 600 may include one or multiple features, components, and/or functionality of examples described herein with reference to other figures.

The system 600 may include a vehicle 602. In some examples, the vehicle 602 may include some or all of the features, components, and/or functionality described above with respect to the vehicle 102. For instance, the vehicle 602 may comprise a bidirectional vehicle. As shown in FIG. 6, the vehicle 602 may also include a vehicle computing device 604, one or more sensor systems 606, one or more emitters 608, one or more communication connections 610, one or more direct connections 612, and/or one or more drive assemblies 614.

The vehicle computing device 604 can, in some examples, include one or more processors 616 and memory 618 communicatively coupled with the one or more processors 616. In the illustrated example, the vehicle 602 is an autonomous vehicle; however, the vehicle 602 could be any other type of vehicle (e.g., automobile, truck, bus, aircraft, watercraft, train, etc.), or any other system having components such as those illustrated in FIG. 6 (e.g., a robotic system, an automated assembly/manufacturing system, etc.). In examples, the one or more processors 616 may execute instructions stored in the memory 618 to perform one or more operations on behalf of the one or more vehicle computing devices 604.

The memory 618 of the one or more vehicle computing devices 604 can store a localization component 620, a perception component 622, a planning component 624, one or more system controllers 626, and a map(s) component 628. Though depicted in FIG. 6 as residing in memory 618 for illustrative purposes, it is contemplated that the localization component 620, perception component 622, planning component 624, one or more system controllers 626, and the map(s) component 628 can additionally, or alternatively, be accessible to the vehicle 602 (e.g., stored on, or otherwise accessible from, memory remote from the vehicle 602, such as memory 636 of one or more computing devices 632).

In at least one example, the localization component 620 can include functionality to receive data from the sensor system(s) 606 to determine a position and/or orientation of the vehicle 602 (e.g., one or more of an x-, y-, z-position, roll, pitch, or yaw). For example, the localization component 620 can include and/or request/receive a map of an environment and can continuously determine a location and/or orientation of the autonomous vehicle within the map. In some instances, the localization component 620 can utilize SLAM (simultaneous localization and mapping), CLAMS (calibration, localization and mapping, simultaneously), relative SLAM, bundle adjustment, non-linear least squares optimization, or the like based on image data, lidar data, radar data, IMU data, GPS data, wheel encoder data, and the like captured by the one or more sensor systems 606 or received from one or more other devices (e.g., computing devices 632) to accurately determine a location of the autonomous vehicle. In some instances, the localization component 620 can provide data to various components of the vehicle 602 to determine an initial position of the autonomous vehicle for generating a trajectory and/or for determining to retrieve map data.

In some instances, the perception component 622 can include functionality to perform object tracking, detection, segmentation, and/or classification. In some examples, the perception component 622 can provide processed sensor data that indicates a presence of an entity that is proximate to the vehicle 602 and/or a classification of the entity as an entity type (e.g., car, pedestrian, cyclist, animal, building, tree, road surface, curb, sidewalk, unknown, etc.). In additional and/or alternative examples, the perception component 622 can provide processed sensor data that indicates one or more characteristics associated with a detected entity (e.g., a tracked object) and/or the environment in which the entity is positioned. In some examples, characteristics associated with an entity can include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc.

In general, the planning component 624 can determine a path for the vehicle 602 to follow to traverse through an environment. For example, the planning component 624 can determine various routes and trajectories and various levels of detail. For example, the planning component 624 can determine a route to travel from a first location (e.g., a current location) to a second location (e.g., a target location). For the purpose of this discussion, a route can be a sequence of waypoints for travelling between two locations. As examples, waypoints may include streets, intersections, global positioning system (GPS) coordinates, etc. Further, the planning component 624 can generate an instruction for guiding the autonomous vehicle along at least a portion of the route from the first location to the second location. In at least one example, the planning component 624 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 602 to navigate.

In at least one example, the vehicle computing device 604 can include one or more system controllers 626, which can be configured to control steering, propulsion, braking, safety, emitters, communication, components, and other systems of the vehicle 602. These system controller(s) 626 can communicate with and/or control corresponding systems of the drive assembly(s) 614 and/or other components of the vehicle 602.

The memory 618 can further include the map(s) component 628 to maintain and/or update one or more maps (not shown) that can be used by the vehicle 602 to navigate within the environment. The map(s) component 628 may include functionality or other components to perform some of the techniques described herein, such as various steps of the processes 100 and 500. For the purpose of this discussion, a map can be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map can include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map can include a three-dimensional mesh of the environment. In some instances, the map can be stored in a tiled format, such that individual tiles of the map represent a discrete portion of an environment and can be loaded into working memory as needed. In at least one example, the one or more maps can include at least one map (e.g., images and/or a mesh). In some examples, the vehicle 602 can be controlled based at least in part on the maps. That is, the maps can be used in connection with the localization component 620, the perception component 622, and/or the planning component 624 to determine a location of the vehicle 602, identify objects in an environment, and/or generate routes and/or trajectories to navigate within an environment.

In some examples, the one or more maps can be stored on a remote computing device(s) (such as the computing device(s) 632) accessible via one or more network(s) 630. In some examples, multiple maps can be stored based on, for example, a characteristic (e.g., type of entity, time of day, day of week, season of the year, etc.). Storing multiple maps can have similar memory requirements but increase the speed at which data in a map can be accessed.

The map(s) component 628 may include a projection component 640, a map generation component 642, and a monitoring component 644. The projection component 640 may project, as projected data, map data onto image data captured by the vehicle 602. For instance, the projection component 640 may receive sensor data (e.g., which may be from log data or the sensor systems 606) that contains at least image data, timestamp data, and altitude data, and project map data reference marks onto the image data such that the map data reference marks may be viewed relative to the features represented in the image data to which they correspond. In other words, the projection component 640 may generate projected data (an output) based at least in part on inputted image data, altitude data, timestamp data, and map data.

The map generation component 642 may include functionality to generate map data representing a road network of an environment. The map data may be stored in the map(s) component by the map generation component 642. Additionally, the map generation component 642 may include functionality to update maps stored by the map(s) component 638. In at least one example, the map generation component 642 may receive lidar data representing a top-down view of an environment, and a cartographer may generate map data based at least in part on the lidar data using the map generation component 642.

The monitoring component 644 may monitor one or more stored maps of the vehicle and determine whether the stored maps accurately represent the environment in which the vehicle 602 is operating. The monitoring component 644 may also monitor semantic data included in the maps to determine whether traffic rules have changed in the environment. For instance, the monitoring component 644 may determine whether a speed limit associated with a road has changed, whether road lanes have been moved, and the like.

In some instances, aspects of some or all of the memory-stored components discussed herein can include any models, algorithms, and/or machine learning algorithms. For example, in some instances, components in the memory 618 (and the memory 636, discussed in further detail below) such as the localization component 620, the perception component 622, and/or the planning component 624 can be implemented as a neural network.

As described herein, an exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In at least one example, the sensor system(s) 606 can include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), image sensors (e.g., camera, RGB, IR, intensity, depth, etc.), audio sensors (e.g., microphones), wheel encoders, environment sensors (e.g., temperature sensors, humidity sensors, light sensors, pressure sensors, etc.), temperature sensors (e.g., for measuring temperatures of vehicle components), etc. The sensor system(s) 606 can include multiple instances of each of these or other types of sensors. For instance, the lidar sensors can include individual lidar sensors located at the corners, front, back, sides, and/or top of the vehicle 602. As another example, the image sensors can include multiple image sensors disposed at various locations about the exterior and/or interior of the vehicle 602. As an even further example, the inertial sensors can include multiple IMUs coupled to the vehicle 602 at various locations. The sensor system(s) 606 can provide input to the vehicle computing device 604. Additionally, or alternatively, the sensor system(s) 606 can send sensor data, via the one or more networks 630, to the one or more computing device(s) 632 at a particular frequency, after a lapse of a predetermined period of time, in near real-time, etc.

The vehicle 602 can also include one or more emitters 608 for emitting light and/or sound. The emitters 608 in this example include interior audio and visual emitters to communicate with passengers of the vehicle 602. By way of example, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitters 608 in this example also include exterior emitters. By way of example, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 can also include one or more communication connection(s) 610 that enable communication between the vehicle 602 and one or more other local or remote computing device(s). For instance, the communication connection(s) 610 can facilitate communication with other local computing device(s) on the vehicle 602 and/or the drive assembly(s) 614. Also, the communication connection(s) 610 can allow the vehicle 602 to communicate with other nearby computing device(s) (e.g., other nearby vehicles, traffic signals, laptop computer 146, etc.). The communications connection(s) 610 also enable the vehicle 602 to communicate with a remote teleoperations system or other remote services.

The communications connection(s) 610 can include physical and/or logical interfaces for connecting the vehicle computing device(s) 604 to another computing device (e.g., computing device(s) 632) and/or a network, such as network(s) 630. For example, the communications connection(s) 610 can enable Wi-Fi-based communication such as via frequencies defined by the IEEE 802.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s).

In at least one example, the direct connection 612 of vehicle 602 can provide a physical interface to couple the one or more drive assembly(s) 614 with the body of the vehicle 602. For example, the direct connection 612 can allow the transfer of energy, fluids, air, data, etc. between the drive assembly(s) 614 and the vehicle 602. In some instances, the direct connection 612 can further releasably secure the drive assembly(s) 614 to the body of the vehicle 602.

In at least one example, the vehicle 602 can include one or more drive assemblies 614. In some examples, the vehicle 602 can have a single drive assembly 614. In at least one example, if the vehicle 602 has multiple drive assemblies 614, individual drive assemblies 614 can be positioned on opposite longitudinal ends of the vehicle 602 (e.g., the leading and trailing ends, the front and the rear, etc.). In at least one example, a single drive assembly 614 of the vehicle 602 may include one or more IMU sensors.

The drive assembly(s) 614 can include many of the vehicle systems and/or components, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive assembly(s) 614 can include a drive assembly controller which can receive and preprocess data from the sensor system(s) and to control operation of the various vehicle systems. In some examples, the drive assembly controller can include one or more processors and memory communicatively coupled with the one or more processors. The memory can store one or more systems to perform various functionalities of the drive assembly(s) 614. Furthermore, the drive assembly(s) 614 may also include one or more communication connection(s) that enable communication by the respective drive assembly with one or more other local or remote computing device(s).

The computing device(s) 632 can include one or more processors 634 and memory 636 that may be communicatively coupled to the one or more processors 634. The memory 636 may store the map(s) component 628. In some examples, the computing device(s) 632 may be associated with a teleoperations system that remotely monitors a fleet of vehicles. Additionally, or alternatively, the computing device(s) 632 may be leveraged by the teleoperations system to receive and/or process data on behalf of the teleoperations system. The map(s) component 628, as well as the projection component 640, the map generation component 642, and the monitoring component 644 may provide off-vehicle functionality of what can be performed on-vehicle by those respective components.

The processor(s) 616 of the vehicle 602 and the processor(s) 634 of the computing device(s) 632 can be any suitable processor capable of executing instructions to process data and perform operations as described herein. By way of example and not limitation, the processor(s) 616 and 634 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 618 and 636 are examples of non-transitory computer-readable media. The memory 618 and 642 can store an operating system and one or more software applications, instructions, programs, and/or data to implement the methods described herein and the functions attributed to the various systems. In various implementations, the memory can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

As can be understood, the components discussed herein are described as divided for illustrative purposes. However, the operations performed by the various components can be combined or performed in any other component. It should be noted that while FIG. 6 is illustrated as a distributed system, in alternative examples, components of the vehicle 602 can be associated with the computing device(s) 632 and/or components of the computing device(s) 632 can be associated with the vehicle 602. That is, the vehicle 602 can perform one or more of the functions associated with the computing device(s) 632, and vice versa.

### Example Clauses

A. A system comprising: one or more processors; and one or more non-transitory computer-readable media storing instructions that, when executed by the one or more processors, cause the system to perform operations comprising: receiving sensor data associated with a vehicle operating in an environment, the sensor data including image data representing a drivable surface of the environment; receiving, based at least in part on the sensor data, map data indicating a boundary associated with the drivable surface; determining a detection of the boundary in the sensor data; projecting, as projected data and based at least in part on a pose of the vehicle, a representation of the boundary into the image data; determining a difference between the detection of the boundary and the representation of the boundary; updating, as an updated map and based at least in part on the difference, the map data such that the boundary is adjusted to be associated with the detected boundary; and transmitting the updated map to an additional vehicle, the additional vehicle configured to navigate the environment based at least in part on the updated map.

B. The system as recited in paragraph A, wherein the boundary is represented by at least one of a road surface marking or a barrier separating the drivable surface from a non-drivable surface.

C. The system as recited in any one of paragraphs A-B, the operations further comprising: determining a detected location of a traffic control indication in the sensor data, the traffic control indication comprising a traffic light or a traffic sign; based at least in part on the map data and the pose of the vehicle, projecting a representation of the traffic control indication into the image data; determining that a difference between the detected location of the traffic control indication and a projected location of the traffic control indication is greater than a threshold difference; and updating the map data to minimize the difference.

D. The system as recited in any one of paragraphs A-C, wherein determining the detection of the boundary in the sensor data comprises: inputting the sensor data into a machine-learned model; and receiving an output from the machine-learned model, the output indicating a location of the boundary in the sensor data.

E. A method comprising: receiving sensor data representing an environment; receiving, based at least in part on the sensor data, map data indicating a traffic control annotation; associating, as projected data, the traffic control annotation with the sensor data based at least in part on one or more of a position or orientation associated with a vehicle; determining, based at least in part on the projected data, an association between the sensor data and the traffic control annotation; and updating the map data based at least in part on the association.

F. The method as recited in paragraph E, further comprising: detecting a traffic control indication associated with the sensor data; and determining a difference between the traffic control indication and the traffic control annotation, wherein updating the map data is based at least in part on the difference.

G. The method as recited in any one of paragraphs E-F, wherein the traffic control annotation comprises one or more of a lane boundary, a road surface marking, a traffic sign, a traffic light, or a crosswalk.

H. The method as recited in any one of paragraphs E-G, wherein the traffic control annotation is indicative of a traffic rule associated with a drivable surface of the environment upon which the vehicle is operating.

I. The method as recited in any one of paragraphs E-H, further comprising receiving altitude data associated with the environment, wherein the associating, as the projected data, the traffic control annotation with the sensor data is further based at least in part on the altitude data.

J. The method as recited in any one of paragraphs E-I, further comprising receiving timestamp data and localization data associated with the sensor data, wherein determining the association between the sensor data and the traffic control annotation is further based at least in part on the timestamp data and the localization data.

K. The method as recited in any one of paragraphs E-J, wherein the sensor data comprises one or more of: image data, lidar data, radar data, or time of flight data.

L. The method as recited in any one of paragraphs E-K, further comprising: determining that a drivable surface of the environment is invalid for use by the vehicle based at least in part on a characteristic associated with the drivable surface that is indicated in the sensor data, the characteristic comprising at least one of a width, surface composition, or condition associated with the drivable surface; and updating a visualization of the map data to indicate that the drivable surface is invalid for use by the vehicle.

M. The method as recited in any one of paragraphs E-L, further comprising sending, to a fleet of vehicles, the updated map data for use by the fleet of vehicles to traverse the environment.

N. The method as recited in any one of paragraphs E-M, further comprising: detecting a traffic control indication associated with the sensor data; determining a difference between the traffic control indication and the traffic control annotation; and sending a request for guidance to a computing device of a teleoperations system associated with the vehicle.

O. The method as recited in any one of paragraphs E-N, further comprising, based at least in part on the association, causing a planning component of the vehicle to associate a greater confidence with the sensor data for determining a planned trajectory for the vehicle.

P. One or more non-transitory computer-readable media storing instructions that, when executed by one or more processors, cause the one or more processors to perform operations comprising: receiving sensor data representing an environment; receiving, based at least in part on the sensor data, map data indicating a traffic control annotation; associating, as projected data, the traffic control annotation with the sensor data based at least in part on one or more of a position or orientation associated with a vehicle; determining, based at least in part on the projected data, an association between the sensor data and the traffic control annotation; and updating the map data based at least in part on the association.

Q. The one or more non-transitory computer-readable media as recited in paragraph P, the operations further comprising: detecting a traffic control indication associated with the sensor data; and determining a difference between the traffic control indication and the traffic control annotation, wherein updating the map data is based at least in part on the difference.

R. The one or more non-transitory computer-readable media as recited in any one of paragraphs P-Q, wherein the traffic control annotation comprises one or more of: a lane boundary, a road surface marking, a traffic sign, a traffic light, or a crosswalk.

S. The one or more non-transitory computer-readable media as recited in any one of paragraphs P-R, wherein the sensor data comprises one or more of image data, lidar data, radar data, or time of flight data.

T. The one or more non-transitory computer-readable media as recited in any one of paragraphs P-S, the operations further comprising sending, to a fleet of vehicles, the updated map data for use by the fleet of vehicles to traverse the environment.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing instructions that, when executed by the one or more processors, cause the system to perform operations comprising:
receiving sensor data associated with a vehicle operating in an environment, the sensor data including image data representing a drivable surface of the environment;
receiving, based at least in part on the sensor data, map data indicating a boundary associated with the drivable surface;
determining a detection of the boundary in the sensor data;
projecting, as projected data and based at least in part on a pose of the vehicle, a representation of the boundary into the image data;
determining a difference between the detection of the boundary and the representation of the boundary;
updating, as an updated map and based at least in part on the difference, the map data such that the boundary is adjusted to be associated with the detected boundary; and
transmitting the updated map to an additional vehicle, the additional vehicle configured to navigate the environment based at least in part on the updated map.

2. The system of claim 1, wherein the boundary is represented by at least one of a road surface marking or a barrier separating the drivable surface from a non-drivable surface.

3. The system of claim 1, the operations further comprising:
determining a detected location of a traffic control indication in the sensor data, the traffic control indication comprising a traffic light or a traffic sign;
based at least in part on the map data and the pose of the vehicle, projecting a representation of the traffic control indication into the image data;
determining that a difference between the detected location of the traffic control indication and a projected location of the traffic control indication is greater than a threshold difference; and
updating the map data to minimize the difference.

4. The system of claim 1, wherein determining the detection of the boundary in the sensor data comprises:
inputting the sensor data into a machine-learned model; and
receiving an output from the machine-learned model, the output indicating a location of the boundary in the sensor data.

5. A method comprising:
receiving sensor data representing an environment;
receiving, based at least in part on the sensor data, map data indicating a traffic control annotation;
associating, as projected data, the traffic control annotation with the sensor data based at least in part on one or more of a position or orientation associated with a vehicle;
determining, based at least in part on the projected data, an association between the sensor data and the traffic control annotation; and
updating the map data based at least in part on the association.

6. The method of claim 5, further comprising:
detecting a traffic control indication associated with the sensor data; and
determining a difference between the traffic control indication and the traffic control annotation,
wherein updating the map data is based at least in part on the difference.

7. The method of claim 5, wherein the traffic control annotation comprises one or more of:
a lane boundary,
a road surface marking,
a traffic sign,
a traffic light, or
a crosswalk.

8. The method of claim 5, wherein the traffic control annotation is indicative of a traffic rule associated with a drivable surface of the environment upon which the vehicle is operating.

9. The method of claim 5, further comprising receiving altitude data associated with the environment, wherein the associating, as the projected data, the traffic control annotation with the sensor data is further based at least in part on the altitude data.

10. The method of claim 5, further comprising receiving timestamp data and localization data associated with the sensor data, wherein determining the association between the sensor data and the traffic control annotation is further based at least in part on the timestamp data and the localization data.

11. The method of claim 5, wherein the sensor data comprises one or more of:
image data,
lidar data,
radar data, or
time of flight data.

12. The method of claim 5, further comprising:
determining that a drivable surface of the environment is invalid for use by the vehicle based at least in part on a characteristic associated with the drivable surface that is indicated in the sensor data, the characteristic comprising at least one of a width, surface composition, or condition associated with the drivable surface; and
updating a visualization of the map data to indicate that the drivable surface is invalid for use by the vehicle.

13. The method of claim 5, further comprising sending, to a fleet of vehicles, the updated map data for use by the fleet of vehicles to traverse the environment.

14. The method of claim 5, further comprising:
detecting a traffic control indication associated with the sensor data;
determining a difference between the traffic control indication and the traffic control annotation; and
sending a request for guidance to a computing device of a teleoperations system associated with the vehicle.

15. The method of claim 5, further comprising, based at least in part on the association, causing a planning component of the vehicle to associate a greater confidence with the sensor data for determining a planned trajectory for the vehicle.

16. One or more non-transitory computer-readable media storing instructions that, when executed by one or more processors, cause the one or more processors to perform operations comprising:
receiving sensor data representing an environment;
receiving, based at least in part on the sensor data, map data indicating a traffic control annotation;
associating, as projected data, the traffic control annotation with the sensor data based at least in part on one or more of a position or orientation associated with a vehicle;
determining, based at least in part on the projected data, an association between the sensor data and the traffic control annotation; and
updating the map data based at least in part on the association.

17. The one or more non-transitory computer-readable media of claim 16, the operations further comprising:
detecting a traffic control indication associated with the sensor data; and
determining a difference between the traffic control indication and the traffic control annotation,
wherein updating the map data is based at least in part on the difference.

18. The one or more non-transitory computer-readable media of claim 16, wherein the traffic control annotation comprises one or more of:
a lane boundary,
a road surface marking,
a traffic sign,
a traffic light, or
a crosswalk.

19. The one or more non-transitory computer-readable media of claim 16, wherein the sensor data comprises one or more of image data,
lidar data,
radar data, or
time of flight data.

20. The one or more non-transitory computer-readable media of claim 16, the operations further comprising sending, to a fleet of vehicles, the updated map data for use by the fleet of vehicles to traverse the environment.
